(19) United States
(12) Patent Application Publication
(10) Pub. No.: US 2012/0064744 A1
(43) Pub. Date: Mar. 15, 2012

(54) Safety Device For Electrical Connectors, Particularly Useful During Installation of Solar Energy Equipment

(76) Inventor: Joseph Messner, Chandler, AZ (US)

(21) Appl. No.: 12/883,129

(22) Filed: Sep. 15, 2010

(51) Int. Cl. H01R 13/44

(52) U.S. Cl. 439/133

(57) ABSTRACT

An electrical safety device comprises a lockable container, the lockable container including a pair of compartments, each one of the compartments capable of holding in electrical isolation one of a respective pair of complementary electrical connectors, each one of the complementary electrical connectors attached to a cable, the cable passing through a hole formed in the lockable container. When the safety device is closed and locked, the electrical connectors are not accessible except to the person with the lock. When the time arrives for the electrical connectors to be connected, the authorized person unlocks the device and connects them. Such a device is of particular importance to installers of solar energy equipment where solar panels are connected in series (in a grid) and the connectors can connect cables carrying high voltage current.

### FIELD OF THE INVENTION

The present invention relates to electrical safety devices. More particularly, it relates to a lockout/tag-out device to secure electrical connectors, particularly useful to ensure worker safety during installation of solar panels.

### BACKGROUND

When electrical equipment is being installed there can be risk that workers will be shocked or electrocuted. Such accidents can occur due to lack of communication among workers throughout a work site. For example, when solar panels are being installed on the roof of a building, workers may connect high voltage electrical cables that cause wiring in other parts of the work site to be energized. However, workers situated below who are unaware of this and come into physical contact with the wiring can be injured or killed.

### SUMMARY OF THE INVENTION

An electrical safety device comprises a lockable container, the lockable container including a pair of compartments, each one of the compartments capable of holding in electrical isolation one of a respective pair of complementary electrical connectors, each one of the complementary electrical connectors attached to a cable, the cable passing through a hole formed in the lockable container.

When the safety device is closed and locked, the electrical connectors are not accessible except to the person with the lock. When the time arrives for the electrical connectors to be connected, the authorized person unlocks the device and connects them. Thus, unauthorized coupling is avoided. Such a device is of particular importance to installers of solar energy equipment where solar panels are connected in series (in a grid) and the connectors can connect cables carrying high voltage current.

These and other aspects, features, and advantages of the present invention will become apparent from the following detailed description of preferred embodiments, which is to be read in connection with the accompanying drawings.

### BRIEF DESCRIPTION OF THE DRAWINGS

FIG. 1 shows an exemplary safety device for electrical connectors, according to a preferred embodiment of the present invention;

FIG. 2 shows the exemplary safety device in a closed position secured with a lock;

FIG. 3 shows the exemplary safety device in an open position;

FIG. 4 shows additional views of the exemplary safety device;

FIG. 5(a) shows a pair of electrical connectors in a connected position;

FIG. 5(b) shows the pair of electrical connectors in an unconnected position; and

FIG. 6 shows the exemplary safety device in a closed position secured with a lock and a tagout device.

### DETAILED DESCRIPTION

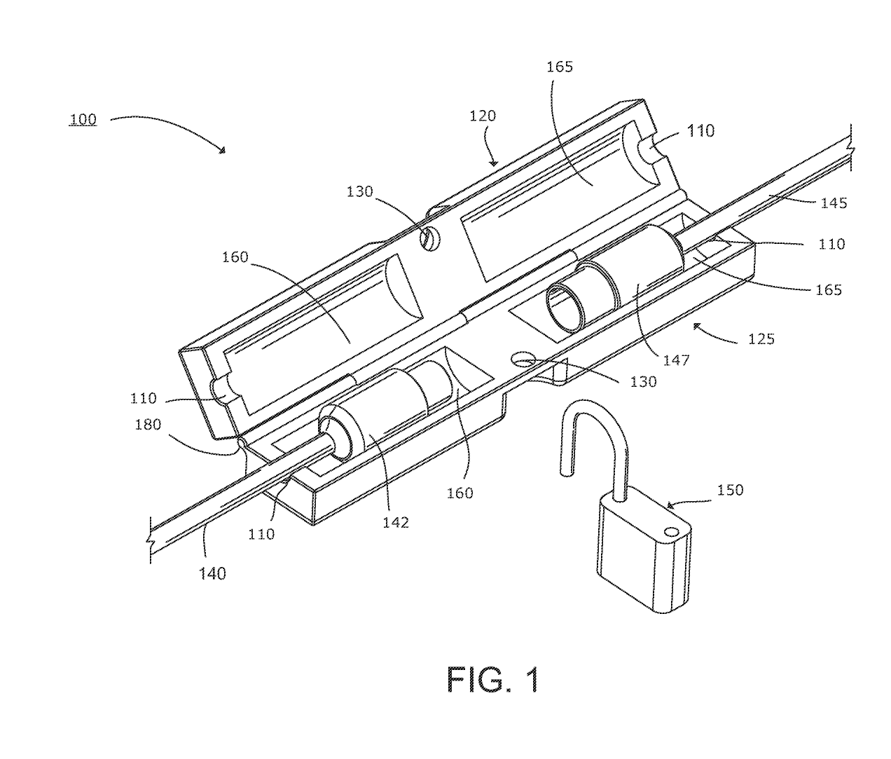

FIG. 1 shows an exemplary safety device 100, according to a preferred embodiment of the present invention. As illustrated, the safety device 100 includes a top portion 120 and a bottom portion 125, the top portion 120 and the bottom portion 125 attached by a hinge 180. As depicted in FIG. 1, the safety device 100 is in the open position. In this position, a first connector 142 with a cable 140 attached thereto can be placed in a first compartment 160, and a second connector 147 with a cable 145 attached thereto can be placed in a second compartment 165. As illustrated, the cables 140, 145 pass through holes 110. Preferably, the compartments 160, 165 will be of sufficient size to accommodate several different types of connectors 142, 147 from various manufacturers, and the holes 110 will be of sufficient diameter to accommodate various gauge cables 140, 145, but still be smaller than any connector 142, 147 that would be used.

The safety device 100 is constructed of a nonconductive material, preferably, plastic. Because the first connector 142 and the second connector 147 are placed in separate compartments which do not allow the connectors 142, 147 to be connected, and, preferably, which are separated by at least half an inch of nonconductive material, the connectors 142, 147 can be safely isolated until such time as they should be connected.

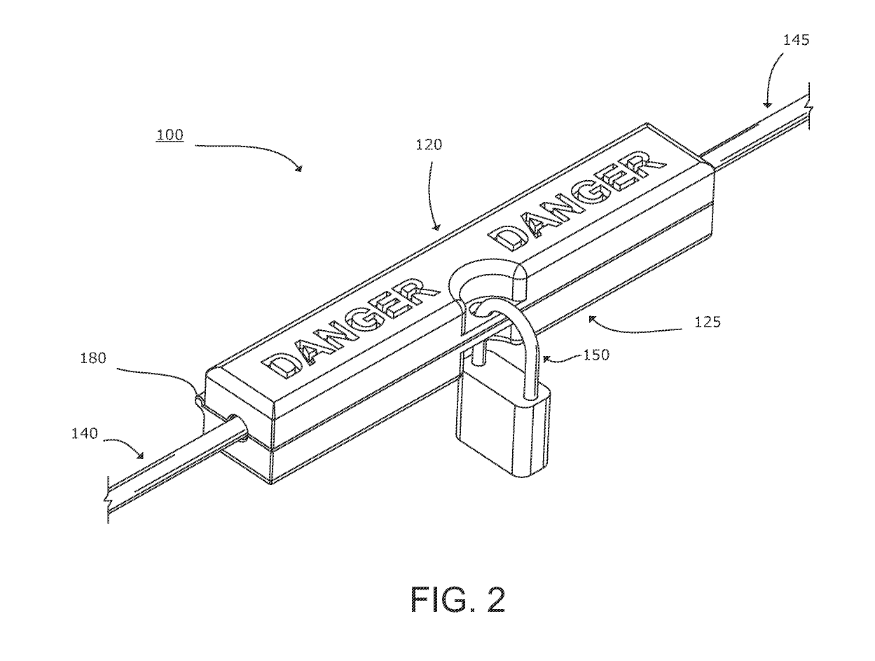

As depicted in FIG. 1, the top portion 120 and the bottom portion 125 each include a fastener hole 130 to accommodate a fastener, such as lock 150. FIG. 2 shows the exemplary safety device 100 in a closed position secured with the lock 150.

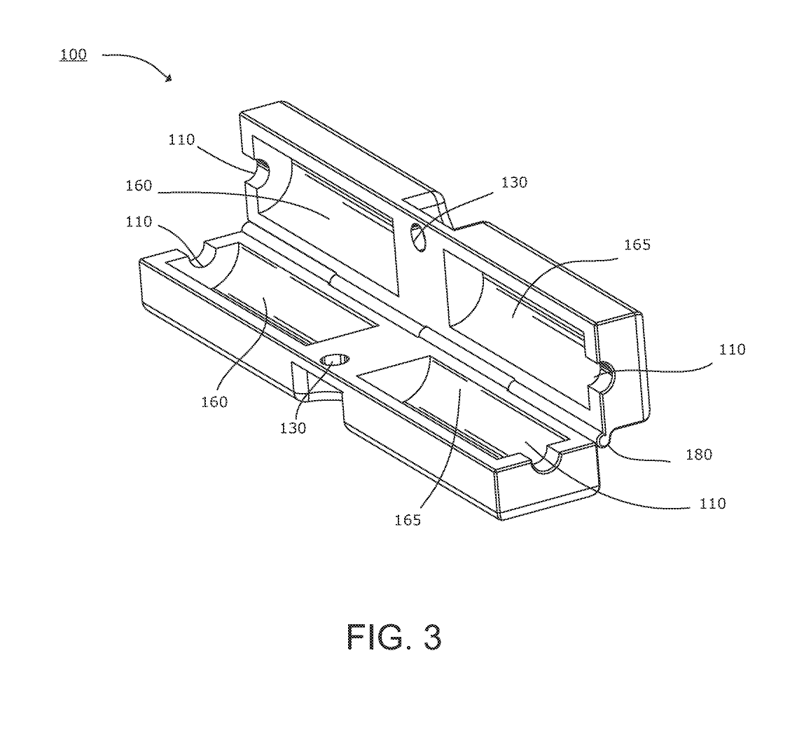

FIG. 3 shows another view of the exemplary safety device 100 in an open position.

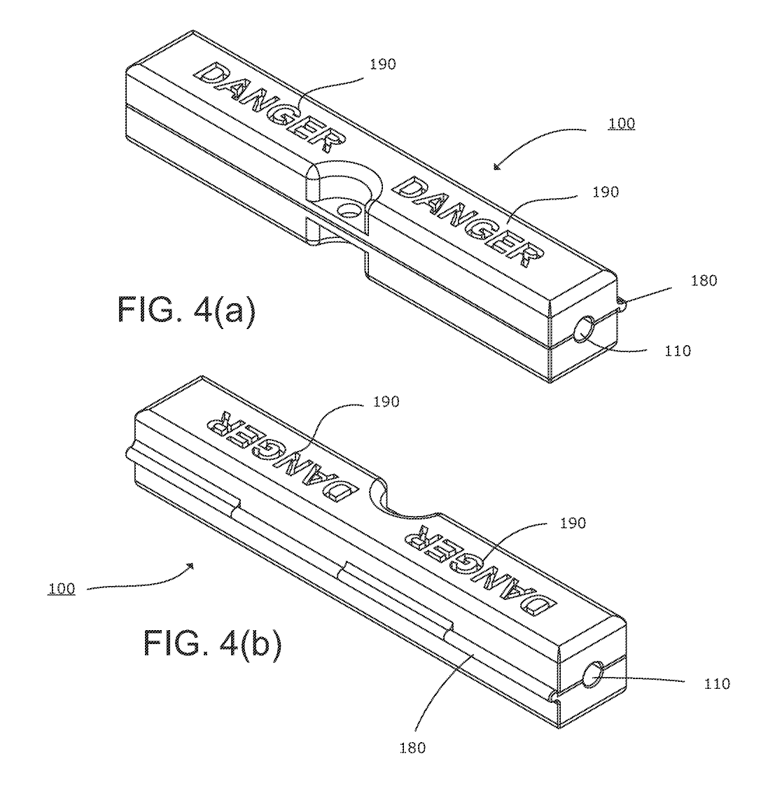

FIG. 4 shows the exemplary safety device 100 with warning indicia 190 displayed on the top portion 120. Preferably, in addition to the warning indicia 190, the safety device 100 will be brightly colored (preferably, red or orange). It is to be understood that different types of warning indicia 190 can be used, including various words, phrases and symbols. Furthermore, it is to be appreciated that the warning indicia 190 can be placed on various parts of the safety device, using various methods, including, for example, direct printing, applying a warning label, etc.

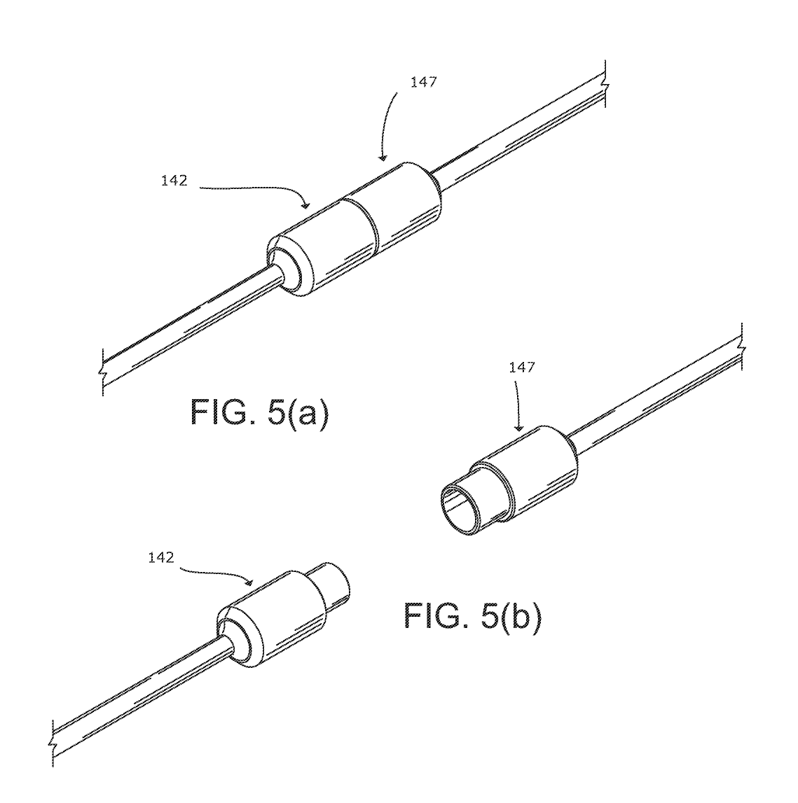

When the safety device 100 is closed and locked, the electrical connectors 142, 147 will not be accessible to unauthorized personnel. However, when the time arrives for the electrical connectors 142, 147 to be connected, an authorized person can unlock the device and connect the connectors 140, 145. (For reference, FIG. 5(a) shows a pair of electrical connectors 142, 147 in a connected position. FIG. 5(b) shows the pair of electrical connectors 142, 147 in an unconnected position.)

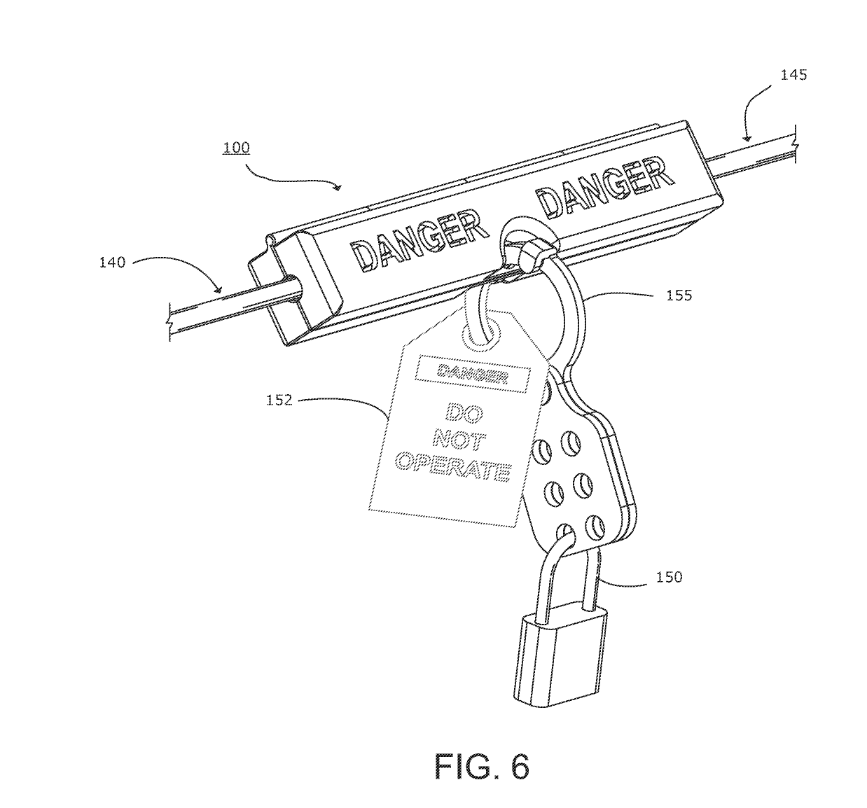

Preferably, the safety device 100 will include a tag having information as to the person(s) responsible for removing the safety device 100. FIG. 6 shows the exemplary safety device 100 in a closed position secured in the preferred manner with the lock 150 and a tag 152 secured to a hasp 155, the hasp 155 secured to lock fastener 130 of the safety device 100.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. An electrical safety device, comprising:
a lockable container, the lockable container including a pair of compartments, each one of the compartments capable of holding in electrical isolation one of a respective pair of complementary electrical connectors, each one of the electrical connectors attached to a cable, the cable passing through a hole formed in the lockable container.

2. The electrical safety device of claim 1, wherein the lockable container includes:
a top portion;
a bottom portion; and
a hinge;
wherein the top portion and the bottom portion are connected using the hinge.

3. The electrical safety device of claim 2, wherein inside surfaces of the top portion and the bottom portion are substantially identical.

4. The electrical safety device of claim 1, wherein the lockable container is made of a nonconductive material.

5. The electrical safety device of claim 4, wherein the nonconductive material is plastic.

6. The electrical safety device of claim 1, wherein the holes formed in the lockable container are positioned on opposite sides of the lockable container.

7. The electrical safety device of claim 1, wherein the lockable container includes a lock.

8. The electrical safety device of claim 1, wherein the lockable container includes a tag.

9. The electrical safety device of claim 1, wherein the lockable container includes warning indicia.

10. The electrical safety device of claim 1, wherein the lockable container includes a hasp.

11. The electrical safety device of claim 10, wherein the hasp includes one or more of a lock and a tag.

12. A method of safely securing an electrical cable, comprising:
using the lockable container of claim 1,
placing a first electrical connector of a first cable in a first one of the pair of compartments, the first cable passing through a first hole in the lockable container;
placing a second electrical connector of a second cable in a second one of the pair of compartments, the second cable passing through a second hole in the lockable container;
closing the lockable container; and
locking the lockable container;
wherein the first electrical connector and the second electrical connector are held in electrical isolation.

13. The method of claim 12, further including tagging the lockable container.

14. A lockout device for a securing a pair of electrical connectors,
means for electrically isolating a pair of complementary electrical connectors; and
means for locking the lockout device.

15. The lockout device of claim 14, further including means for tagging the lockout device.
